(19) United States
(12) Patent Application Publication
(10) Pub. No.: US 2026/0036822 A1
(43) Pub. Date: Feb. 5, 2026

(54) DIFFRACTIVE OPTICAL ELEMENT AND CAMERA

(71) Applicant: Zhangzhou Qixiang Intelligent Technology Co., Ltd, Zhangzhou (CN)

(72) Inventor: Chia Wei Hsu, New Taipei (TW)

(21) Appl. No.: 18/882,738

(22) Filed: Sep. 11, 2024

(30) Foreign Application Priority Data
Aug. 2, 2024 (CN) 202411057912.2

(51) Int. Cl. G02B 27/42; G03B 17/56

(52) U.S. Cl. CPC G02B 27/4216; G03B 17/565

(57) ABSTRACT

A diffractive optical element and a camera are disclosed. The diffractive optical element may be arranged at a camera head of a camera for assisting the camera in imaging. The diffractive optical element may be configured by inverse design. The diffractive optical element is inversely designed to minimize stray spots during image capture and to enhance its light transmission capability. The inverse design is applied to reduce an etching depth of a patterned region in the diffractive optical element, thereby lowering primary and secondary diffraction efficiency, increasing light transmission capacity, and minimizing stray spots in captured images. The inverse design is further applied to narrow the patterned region in the diffractive optical element, thereby lowering diffraction efficiency and increasing light intake through a light transmissive region, which enables a camera aperture to obtain more light, enhancing background light intake, shutter response speed, and overall quality in imaged background.

### CROSS REFERENCE TO RELATED APPLICATIONS

The present application claims the benefit of Chinese Patent Application No. 2024110579122 filed on Aug. 2, 2024, the contents of which are incorporated herein by reference in their entirety.

### TECHNICAL FIELD

The present disclosure relates to the field of imaging technology, and in particular to a diffractive optical element and a camera.

### BACKGROUND

With the development of terminal technology, the photographic performance of these devices continues to improve. Terminal devices are increasingly integrated into our work, daily life, and social interactions. Especially on today's rich and diverse social platforms, people are accustomed to uploading images to showcase their lifestyles.

To achieve a better display effect, people often use image editing software to enhance captured images by adding patterns and expressions. However, such elements added by the image editing software often fail to blend seamlessly with the image, creating a sense of abruptness that detracts from the overall display effect. Additionally, using image editing software to add these elements requires a certain level of skill, creating a barrier for some users. It also demands significant time and effort, reducing convenience.

Additionally, Diffractive Optical Elements (DOEs) are emerging optical components that have gained significant attention in recent years, with their basic operating principle rooted in diffraction. When light emitted from a point source enters a diffractive optical element, its surface with a diffractive structure splits the beam into multiple rays, which can be redirected, shaped, or combined in various ways to produce a diffraction pattern. Traditionally, diffractive optical elements have been primarily applied to lasers, focusing on achieving high diffraction efficiency through forward design. However, when directly applied to cameras, these high-efficiency diffractive optical elements can significantly obscure the camera aperture, leading to a degradation in image quality and the appearance of stray spots in the captured images.

### SUMMARY

To solve the problem of high diffraction efficiency in a diffractive optical element causing stray spots to appear on a captured image, a diffractive optical element and a camera are disclosed, utilizing inverse design to reduce an etching depth of a patterned region in the diffractive optical element, thereby lowering primary and secondary diffraction efficiency to minimize stray spots in captured images, and to increase the light transmission capacity of the diffractive optical element to enable a camera aperture to obtain more light, enhancing background light intake, shutter response speed, and overall quality in imaged background.

In a first aspect, an embodiment discloses a diffractive optical element, which may be arranged at a camera head of a camera for assisting the camera in imaging.

The diffractive optical element may be configured by inverse design.

The diffractive optical element may be inversely designed to minimize stray spots during image capture and to enhance its light transmission capability;

The inverse design may be applied to reduce an etching depth of a patterned region in the diffractive optical element, thereby lowering primary and secondary diffraction efficiency, increasing light transmission capacity, and minimizing stray spots in captured images; and

The inverse design may be further applied to narrow the patterned region in the diffractive optical element, thereby increasing light intake through a light transmissive region of the diffractive optical element, which enables a camera aperture to obtain more light, enhancing background light intake, shutter response speed, and overall quality in imaged background.

In some alternative embodiments, an etching depth value may be determined via auxiliary software design for the diffractive optical element, and an actual etching depth is reduced to a range between 20% and 80% of the designed etching depth value depending on patterning complexity, in order to lower the diffraction efficiency of the diffractive optical element.

In some alternative embodiments, the patterned region in the diffractive optical element may have a dimension less than or equal to a spacing size between adjacent patterned regions in the diffractive optical element.

In some alternative embodiments, the inverse design may be further applied to enlarge the light transmissive region in the diffractive optical element in order to enable the camera aperture to obtain more light.

In some alternative embodiments, the light transmissive region in the diffractive optical element may have a dimension greater than or equal to the dimension of the patterned region.

In some alternative embodiments, the patterned region of the diffractive optical element may be configured with 100 to 1000 sampling points, depending on the patterning complexity, a higher number of sampling points leads to more refined light spots, and in the case where the dimension of the patterned region is fixed, increasing the number of sampling points results in a thinner processing line width, which facilitates the reduction of stray spots.

In some alternative embodiments, the etching depth of the patterned region will affect its light transmittance, and the actual etching depth may be reduced to a range between 20% and 80% of the designed etching depth value in order to improve the light transmittance of the patterned region.

In some alternative embodiments, if a symmetrical pattern is required in the patterned region of the diffractive optical element, the pattern may be prepared in 2 orders by a single etching.

If an asymmetrical pattern is required in the patterned region of the diffractive optical element, the pattern may be prepared in 4 orders by double etching.

In some alternative embodiments, as the camera aperture varies from larger to smaller, a corresponding amount of light intake changes from more to less.

As the dimension of the patterned region in the diffractive optical element varies from smaller to larger, corresponding occlusion of the aperture increases from less to more, leading to a reduction in the amount of light intake from more to less.

An increased amount of light intake will shorten shutter time, achieving the same exposure in a shorter duration, thereby preventing image blurring when photographing fast-moving objects.

The dimension of the light transmissive region in the diffractive optical element may be enlarged in a dark environment, allowing for an increased amount of light intake to achieve the same exposure duration with lower sensitivity, resulting in cleaner, high signal-to-noise ratio images.

In a second aspect, another embodiment discloses a camera comprising a diffractive optical element as described above.

The diffractive optical element may be detachably attached to a camera head of a camera.

The above solutions provided by the embodiments of the disclosure has the following advantages.

By utilizing the diffractive optical element and the camera described in embodiments of the disclosure, the diffractive optical element can be arranged at a camera head of a camera for assisting the camera in imaging. The diffractive optical element can be configured by inverse design in such a way that the diffractive optical element can be inversely designed to minimize stray spots during image capture and to enhance its light transmission capability. The inverse design can be applied to reduce the etching depth of a patterned region in the diffractive optical element, thereby lowering primary and secondary diffraction efficiency to minimize stray spots in captured images. The inverse design can be further applied to narrow the patterned region in the diffractive optical element, thereby lowering diffraction efficiency. This allows the camera aperture to obtain more light, enhancing background light intake, shutter response speed, and overall quality in imaged background.

### BRIEF DESCRIPTION OF THE DRAWINGS

In order to more clearly explain the embodiments and advantages of the disclosure or the solutions in the existing technologies, drawings that need to be used in the description of the embodiments or the existing technologies will be briefly introduced below. Obviously, the drawings in the following description are only some embodiments of the disclosure. For those of ordinary skill in the art, other drawings can be obtained based on these drawings without any creative work.

FIG. 1 illustrates a schematic structure of a camera using a diffractive optical element according to an embodiment of the disclosure;

FIG. 2 illustrates a schematic diagram depicting the relationship between an aperture, transmissive region dimension, patterned region dimension, shutter, light intake, and imaging quality, according to an embodiment of the disclosure.

FIG. 3 illustrates a schematic diagram of a diffractive optical element according to an embodiment of the disclosure;

FIG. 4 illustrates an image captured of a diffraction pattern formed by a diffractive optical element with high diffraction efficiency, according to an embodiment of the disclosure.

FIG. 5 illustrates a schematic diagram depicting the relationship between aperture size and the amount of light intake according to an embodiment of the disclosure; and

FIG. 6a and FIG. 6b illustrate schematic diagrams of two diffractive optical elements according to embodiments of the disclosure.

### LIST OF REFERENCES

10—diffractive optical element; 11—patterned region; 12—light transmissive region; 20—camera; 21—aperture; 22—light sensor.

### DETAILED DESCRIPTION OF THE EMBODIMENTS

The technical solutions provided by the embodiments of the disclosure will be clearly described in details in conjunction with the accompanying figures showing exemplary embodiments of the invention. Obviously, the described embodiments are only a part of the embodiments of the present invention, rather than all the embodiments thereof. All other embodiments derived from the disclosed embodiments by those of ordinary skill in the art without any creative effort will fall within the scope of the disclosure.

It is to be understand that the term “an embodiment” or “embodiments” in the description of the disclosure refers to a particular feature, structure or characteristic that can be included in at least one implementation of the disclosure. In the description, appended claims and accompanying drawings of the disclosure, it is to be understood that the terms “above”, “below”, “bottom”, “top” and the like indicate orientations or positional relationships depending on those shown in the drawings, and are intended merely to facilitate and simplify the description of the disclosure, rather than indicating or implying that an apparatus or element referred to must have a particular orientation or be constructed and operated in a particular orientation, and therefore will not to be interpreted as limiting the disclosure. The terms “first” and “second” are used merely for descriptive purposes and should not be interpreted as indicating relative importance or implicitly specifying the number of mentioned features. Thus, a feature defined with the terms “first” and “second” may explicitly or implicitly include one or more of such features. Moreover, terms such as “first” and “second” are used to distinguish similar objects, and are not necessarily intended to describe a particular order or sequence. It should be understood that the data used may be interchanged, where appropriate, allowing the embodiments of the disclosure to be implemented in an order different from that illustrated or described herein. Furthermore, in the description of these embodiments, the term “multiple” refers to two or more, unless otherwise indicated. In addition, the terms “comprise”, “include” and “have,” along with any variations thereof, are intended to cover non-exclusive embodiments. For example, a process, method, system, or product comprising a series of steps or units is not necessarily limited to those steps or units explicitly listed. Instead, it may include other steps or units not explicitly listed or inherent to those processes, methods, products, or equipment.

To clarify the purposes, technical solutions, and advantages presented in the embodiments of the disclosure, the following sections provide a more detailed description, in conjunction with the accompanying drawings and specific embodiments. It should be understood that the specific embodiments described herein are provided solely for the purpose of explaining the embodiments of the disclosure and are not intended to limit them in any way.

To enable convenient rendering of a pattern on an image without the need for image editing software, a diffractive optical element may be incorporated into the camera when capturing background images. The diffractive optical element described in the embodiments of the disclosure is either a Diffractive Optical Element (DOE) or a Holographic Diffractive Optical Element (HDOE) structure.

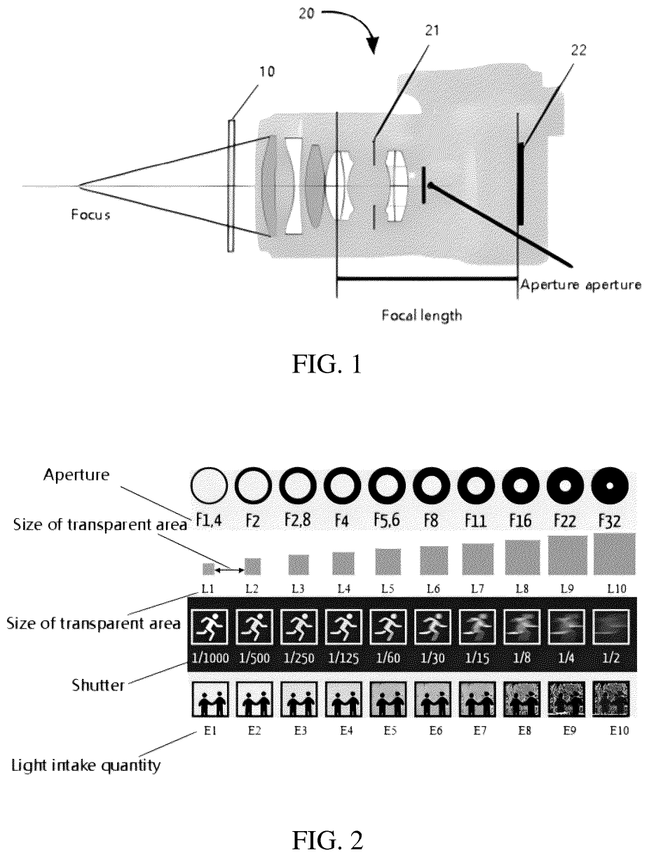

FIG. 1 is a schematic diagram illustrating the structure of a camera using a diffractive optical element, according to an embodiment of the disclosure. As shown in FIG. 1, the diffractive optical element can be arranged at the camera to assist in the imaging process. The diffractive optical element includes a patterned region and a light transmissive region. The patterned region is configured to generate a diffraction pattern based on the imaging of a point light source in a shooting environment. Meanwhile, light from the environment can pass directly through the light transmissive region and enter an aperture of the camera, enabling the camera to capture the environment. During this process, the camera simultaneously captures the diffraction pattern on the background image of the environment, allowing the pattern to blend seamlessly with the background during imaging. This integration prevents the pattern from appearing abrupt or out of place, thereby enhancing the overall image display effect. Additionally, since the diffractive optical element can be installed directly on a head of the camera, it eliminates the need for specialized skills or additional time and effort to edit captured images. This greatly enhances the convenience of use.

However, when the diffractive optical element is placed on the camera, the patterned region will obscure the aperture, reducing the amount of light intake. This leads to slower shutter response speeds and a decrease in the quality of the camera's background imaging. Moreover, when the diffractive optical element is forward-designed, its high diffraction efficiency can cause stray light spots to appear on the captured background image. To avoid these issues, the diffractive optical element according to embodiments of the disclosure is configured by inverse design in such a way that the diffractive optical element can be inversely designed to minimize stray spots during image capture and to enhance its light transmission capability. The inverse design may be applied to reduce the etching depth of a patterned region in the diffractive optical element, thereby lowering primary and secondary diffraction efficiency to minimize stray spots in captured images. The inverse design may be further applied to narrow the patterned region in the diffractive optical element, thereby lowering diffraction efficiency. This allows the camera aperture to obtain more light, enhancing background light intake, shutter response speed, and overall quality in imaged background.

As shown in FIG. 1, a camera 20 typically includes an aperture 21, a light sensor 22, and other components. The aperture 21 is a component in the camera that controls the amount of light entering the light sensor. It can be considered as a small circular opening. The amount of light that passes through the aperture 21 and enters the light sensor is referred to as the light intake. As the aperture 21 becomes larger, the light intake gradually increases; the larger the aperture, the greater the amount of light intake.

In camera imaging, aperture, shutter, and sensitivity are commonly referred to as the “three elements of exposure.” Aperture refers to the size of a lens opening, which influences both the depth of field and the exposure of a photo. shutter is a component in the camera that controls the exposure duration. Generally, a slower shutter speed allows more incoming light, with the shutter speed determining the length of the exposure. Sensitivity (often referred to as ISO) is used to adjust the camera's responsive to light. The higher the sensitivity, the more responsive the camera is to light. For camera imaging, with a small aperture, high-speed shutter, or low sensitivity, less light intake is achieved, resulting in a darker photo. Conversely, with a large aperture, low-speed shutter, or high sensitivity, more light intake is achieved, resulting in a brighter photo.

FIG. 2 illustrates a schematic diagram depicting the relationship between an aperture, transmissive region dimension, patterned region dimension, shutter, light intake, and imaging quality, according to an embodiment of the disclosure. As shown in FIG. 2, the first row depicts apertures progressing from smaller on the left to larger on the right. The larger the aperture, the greater the light intake, resulting in a brighter photo. Conversely, the smaller the aperture, the less the light intake, resulting in a darker photo. The second row here depicts dimensions of the individual patterned regions in the diffractive optical elements, from the leftmost patterned region with the smallest dimension corresponding to largest spacing between adjacent patterned regions, to the rightmost patterned region with the largest dimension corresponding to the smallest spacing between adjacent patterned regions. As the dimensions of the patterned regions in diffraction optics increase from small to large, the spacing between adjacent patterned regions-essentially, the dimension of the light transmissive region-decreases from large to small. This means that the occlusion of the aperture by the patterned regions increases from less to more, correspondingly reducing the amount of light intake from more to less. The third row here depicts shutter speeds, from the leftmost high-speed shutter corresponding to a clearest human image, to the rightmost low-speed shutter corresponding to a most blurry human image. With a fixed aperture, the slower the shutter speed, the longer the light enters the camera, resulting in more light and a brighter picture, but it can cause blurriness when photographing fast-moving objects. Conversely, the faster the shutter speed, the shorter the light enters the camera, resulting in less light and a darker picture, but it allows for freezing the motion of moving objects. Finally, the fourth row here depicts light intakes, from the leftmost rich light intake corresponding to a clearest image, to the rightmost poor light intake corresponding to a most blurry image.

As shown in FIG. 2, the dimension of the individual patterned region increases sequentially from L1 to L10. For example, L1 is 0.3 mm, L2 is 0.35 mm, L3 is 0.4 mm, L4 is 0.45 mm, L5 is 0.5 mm, L6 is 0.55 mm, L7 is 0.6 mm, L8 is 0.65 mm, and L9 is 0.75 mm. When the diffractive optical element is positioned at the camera head, the larger the dimension of the individual patterned region, the more the aperture in the camera head is blocked, leading to a lower amount of light intake. As the dimension of the individual patterned region increases sequentially from L1 to L10, the spacing between adjacent patterned regions becomes smaller, corresponding to a reduction in aperture size from F1.4 to F32. Correspondingly, the amount of light intake decreases from E1 to E10. As shown in FIG. 2, this decrease in light intake leads to the gradual blurring of the captured images.

When imaging with a camera, less light entering the camera results in a slower shutter response speed. Additionally, when photographing with a hand-held camera, some shaking is inevitable, and the slower the shutter response speed, the more noticeable the shake will be in a captured image. Also, insufficient light intake can lead to blurring of the image. Exemplarily, as shown in FIG. 2, when the dimension of individual patterned region increases from L1 to L10, the shutter response speed decreases from 1/1000 to ½. Correspondingly, the brightness of the captured image decreases sequentially, the clarity diminishes, and eventually, the image becomes so blurred that it is hard to recognize. Therefore, embodiments of the disclosure utilize a possible smallest patterned region to minimize the occlusion of the aperture in the camera head by the diffractive optical element, thereby increasing the amount of light intake. This also enhances the shutter response speed, reduces the likelihood of image blur due to jitter, and ultimately improves the overall imaging quality of the camera in various aspects.

In embodiments of the disclosure, by reducing the dimension of the patterned region in the diffractive optical element, the dimension of the light transmissive region is relatively increased. This allows more light from the background to pass through the diffractive optical element and enter the camera aperture. In some embodiments, the inverse design is further applied to enlarge the light transmissive region in the diffractive optical element, with widening the spacing between neighboring patterned regions. This adjustment allows more light to enter the camera aperture, enhancing light intake.

As the camera aperture decreases from large to small, the amount of light intake reduces accordingly. Similarly, as the dimension of the patterned region in the diffractive optical element varies from smaller to larger, corresponding occlusion of the aperture increases from less to more, leading to a reduction in the amount of light intake from more to less. An increased amount of light intake will shorten shutter time, achieving the same exposure in a shorter duration, thereby preventing image blurring when photographing fast-moving objects. The dimension of the light transmissive region in the diffractive optical element will be enlarged in a dark environment, allowing for an increased amount of light intake to achieve the same exposure duration with lower sensitivity, resulting in cleaner, high signal-to-noise ratio images.

To better understand the design concept of the disclosure, the disclosed solutions are described below in relation to the role of the diffractive optical element in the photographing process of the camera.

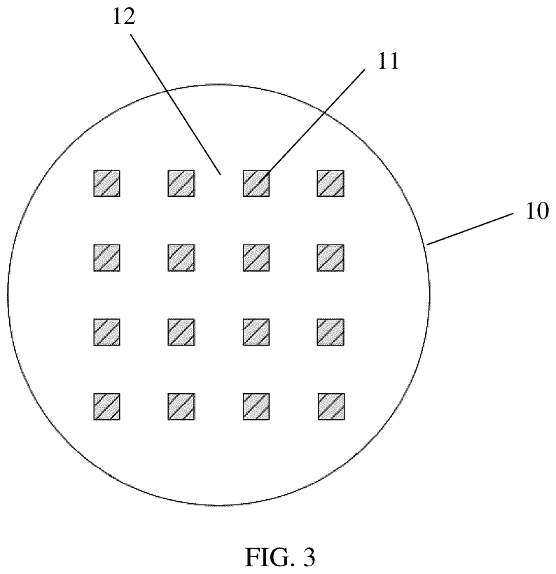

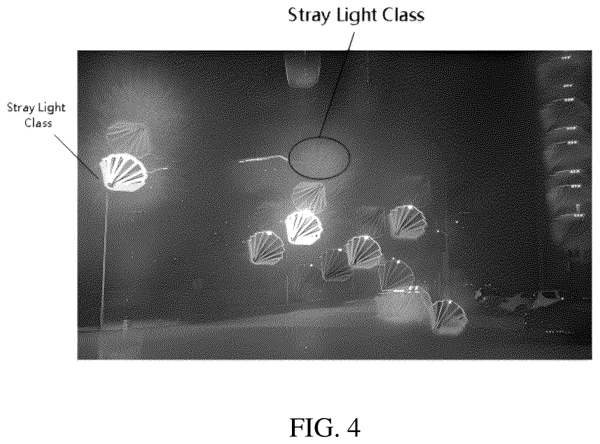

FIG. 3 illustrates a schematic diagram of a diffractive optical element 10 according to an embodiment of the disclosure. As shown in FIG. 3, the diffractive optical element 10 may include a patterned region 11 and a light transmissive region 12. Optionally, the diffractive optical element 10 includes a predetermined number of patterned regions 11, with adjacent patterned regions 11 separated by the light transmissive region 12. In practice, as shown in FIG. 3, the patterned regions 11 in the diffractive optical element 10 are often arranged in an array, with the light transmissive region 12 positioned between neighboring patterned regions 11, separating them from each other. The patterned regions 11 are used to create a diffraction pattern, allowing the camera to simultaneously capture both the diffraction pattern and the background. Specifically, optical microstructures are formed within the patterned regions 11, which can produce a diffraction pattern when illuminated by a point light source. Optionally, the point light source may be incandescent light, candlelight, or other similar sources. The diffraction pattern can optionally include one or more of words, expressions, symbols, or patterns. The background may be a figure, a landscape, a building, etc., and the embodiments of the disclosure do not impose any limitation thereon. No optical microstructure is present in the light transmissive region 12, allowing light from the background to pass directly through this area.

When the diffractive optical element is positioned at the camera head and the camera is used to image the background, such as photographing the background, the light emitted from a point light source in the environment irradiates the patterned region 11. Due to the diffraction effect of the optical microstructures, a corresponding diffraction pattern is generated, which can then be captured by the camera. At the same time, light from the environment passing through the light transmissive region 12 can also be captured by the camera. When the shutter of the camera is activated, both the diffraction pattern and the background are captured simultaneously, resulting in an image that includes both the diffraction pattern and the background. In this image, the pattern is captured in the same environment as the background, so the pattern integrates seamlessly into the final image, resulting in a more natural presentation.

It should be noted that during the camera imaging process, the diffraction pattern is formed depending on the point light source, while the background is captured depending on the ambient light. The brightness of the point light source and the overall photo background are different. That is, the intensity of the point light source primarily affects the brightness of the imaged pattern, with little impact on the overall brightness of the background in the photo. During the imaging process, a light sensor of the camera detects the light intensity of the overall imaging environment.

For the diffractive optical element 10, diffraction efficiency is a key measure of its performance. Diffraction efficiency refers to the ability of the diffractive optical element 10 to convert the incident light energy into light energy at a specific diffraction order during the diffraction process. The higher the diffraction efficiency, the stronger the conversion ability of the diffractive optical element 10. Generally, once light passes through the diffractive optical element 10, multiple diffraction orders are generated. Typically, only the primary order of diffracted light is focused on, while the diffracted light from other orders creates stray light on the primary diffraction image surface. Currently, the diffractive optical element 10 is primarily applied in fields such as spectral analysis, laser technology, and optical information processing. In these fields, to minimize energy loss, it is usually necessary to maximize the diffraction efficiency of the diffractive optical element 10. However, while increasing diffraction efficiency reduces energy loss, it also relatively increases the energy of stray light. When the diffractive optical element 10 is applied to a camera, the camera's high sensitivity can cause it to capture not only the diffracted image but also any stray light. If the energy of the stray light is strong, this will result in stray spots appearing on the captured image.

FIG. 4 illustrates an image captured of a diffraction pattern formed by a diffractive optical element with high diffraction efficiency, according to an embodiment of the disclosure. As shown in FIG. 4, multiple diffraction patterns of varying lightness and darkness appear on the image, some of these diffraction patterns are formed by the primary level of diffracted rays, but the majority are created by other levels of diffracted rays. These diffraction patterns significantly obscure the background elements (such as street lamps and road surfaces) in the image, preventing the clear display of the background. This results in a reduced overall display effect.

To avoid the issues described above, embodiments of the disclosure uniquely employ an inverse design approach. Instead of pursuing high diffraction efficiency, this approach intentionally reduces the diffraction efficiency of the diffractive optical elements. This reduction in efficiency minimizes stray spots, while simultaneously improving the light transmission through the diffractive optical elements. As a result, the camera can capture images with a softer imaging effect and a background with higher-definition clarity.

Embodiments of the disclosure provide a diffractive optical element that can be applied to a camera to achieve high-definition imaging. Such an element ensures that the camera's ability to capture high-definition backgrounds (e.g., landscapes, people, etc.) is not significantly compromised while also capturing diffractive patterns. The diffraction pattern (such as graphic or text) is imaged under a point light source (e.g., street lamp, candlelight, etc.), allowing the camera to capture a unique image, which can then be turned into a personalized emotion to be shared and interacted with friends on social platforms.

In embodiments of the disclosure, the light energy conversion capability of the diffractive optical element 10 can be reduced by employing inverse design, which decreases the diffraction efficiency of the diffractive optical element 10. Specifically, the diffraction efficiency of the diffractive optical element 10 is designed to be less than or equal to a predetermined value. In this manner, although the light energy of the primary diffraction order is reduced, resulting in a darker diffraction pattern, the reduction has an even greater impact on the light energy of the other diffraction orders. This causes the diffraction patterns formed by light from the other diffraction orders to become significantly darker or even disappear entirely. When the diffraction pattern is photographed, the camera cannot capture the diffraction patterns formed by the light of the other diffraction orders. This substantially reduces stray spots on the photographed image, allowing the background to be clearly displayed and improving the overall display effect.

It is worth noting that although reducing the diffraction efficiency of the diffractive optical element 10 may result in a darker diffraction pattern formed by the light of primary diffraction order, such a design will not negatively impact the ultimate goal of the disclosure. The purpose is to simultaneously image the diffraction pattern and the background, ensuring that the pattern blends seamlessly with the background during the imaging process. Instead, this approach can enhance the clarity of the image and improve the overall quality of the imaged background.

In embodiments of the disclosure, an optical microstructure is formed in each patterned region 11, and this microstructure is created by etching a substrate. Optionally, the etching of the substrate can be performed using techniques such as photolithography, laser etching, plasma etching. In some embodiments, the microstructures formed in the patterned regions 11 can also be created using techniques such as hot press molding, UV (Ultra-Violet) imprinting, coating, UV transfer printing. As an example, an embossing adhesive is coated and dried on the substrate, and then nanoimprinting is performed on the embossing adhesive using a flexible film plate. Optical microstructures are formed on the substrate by curing the embossing adhesive and releasing it by employing UV light.

The depth at which the substrate is etched will influence the transmittance of light. Generally, a shallower etching depth of the substrate results in higher light transmittance in the patterned region 11, while a deeper etching depth leads to lower light transmittance in the patterned region 11.

Generally, an etching depth value is determined via auxiliary software design for the diffractive optical element. Forward design typically results in a deeper etching depth. To reduce the diffraction efficiency and improve light transmittance in a patterned region, the actual etching depth is often reduced compared to the designed value. Specifically, to ensure the integrity of the pattern structure in the processed patterned region, the etching depth of the substrate should be minimized as much as possible during the etching process to obtain the patterned region 11. In practice, depending on patterning complexity, an actual etching depth is reduced to a range between 20% and 80% of the designed etching depth value, in order to lower the diffraction efficiency of the diffractive optical element. For example, if the designed etching depth value is 7000 Å, reducing it to 70% would result in an actual etch depth of 4900 Å for the diffractive optical element. By reducing the etching depth, the light transmittance of the patterned region can be significantly increased. Additionally, this reduction in etching depth also lowers the diffraction efficiency of the diffractive optical element 10, which helps to minimize stray spots in the images captured by the camera.

In some embodiments, when processing the diffractive optical element 10, the transcription rate of a replica template can be lowered by reducing the hot pressing temperature. This adjustment decreases the etching depth, ensuring that the resulting diffractive optical element 10 has high light transmittance while also reducing stray spots in the images captured by the camera.

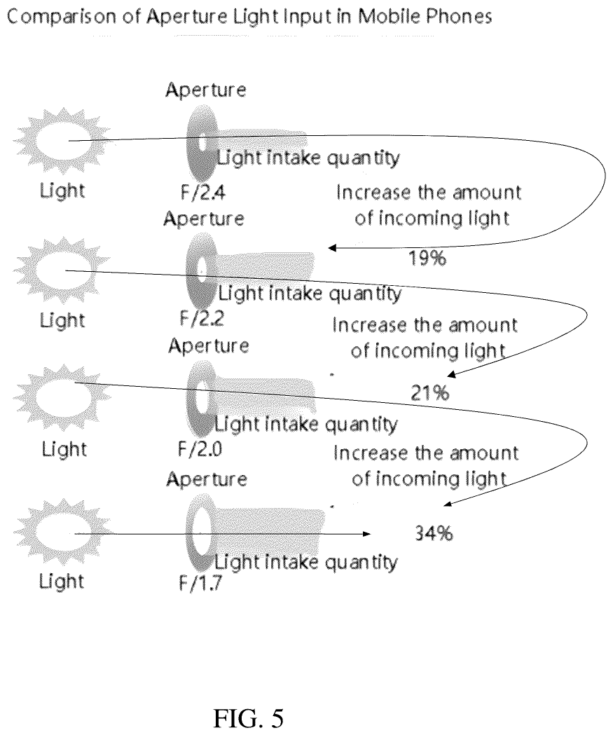

FIG. 5 illustrates a schematic diagram depicting the relationship between aperture size and the amount of light intake according to an embodiment of the disclosure. In FIG. 5, the amount of light entering the photosensitive element through the aperture is called the amount of incoming light. The amount of light entering will gradually increase as the aperture increases, the larger the aperture, the greater the amount of light entering. As shown in FIG. 5, an aperture of F/2.2 enhances the amount of light intake by 19% compared to an aperture of F/2.4, an aperture of F/2.0 increases light intake by 21% compared to F/2.2, and an aperture of F/1.7 boosts light intake by 34% compared to F/2.0. Normally, the size of the aperture is determined by the aperture setting and focal length of the camera. After light passes through the camera lens, it then travels through the aperture to reach the light sensor. Therefore, the larger the camera aperture, the more light passes through it per unit of time, resulting in richer information being captured by the sensor and ultimately producing a better-quality picture. In addition, the size of the aperture directly influences the shutter speed. The shutter controls the duration for which light is allowed to enter the camera, and a larger aperture allows more light to enter, enabling the camera shutter to operate faster. The automatic shutter response speed directly impacts the photo quality, as a slower shutter speed increases the likelihood of blur due to hand shaking, resulting in a poorer imaging effect.

In an implementation of the disclosure, the diffractive structure placed in front of the lens will influence the amount of ambient light entering the aperture and the intensity of that light. This, in turn, affects the light-sensing performance of the sensor and ultimately impacts the quality of the captured image. Referring back to FIG. 1, when the diffractive optical element 10 is placed at the camera, the patterned region 11 in the diffractive optical element will block a portion of the aperture. The larger the patterned region 11, the greater the portion of the aperture that will be blocked. If the patterned region 11 in the diffractive optical element 10 is too large, the camera may not capture enough light from the background when photographing the background. This insufficient light intake can cause the camera shutter to slow down, resulting in blurring and other issues in the final image, thereby affecting the quality of the image display.

To avoid these problems, by embodiments of the disclosure, the area of the patterned region 11 in the diffractive optical element 10 is reduces and the area of the light transmissive region 12 is increased. This approach can minimize the blockage of the aperture in the camera head, ensuring that the camera can quickly gather sufficient light from the background. This prevents shutter slowdown and enables high-definition shooting of the background.

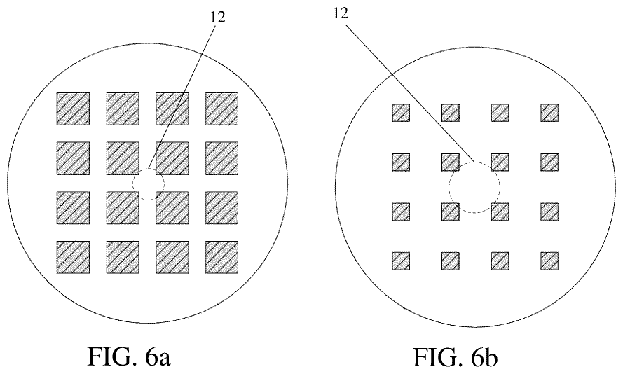

FIG. 6a and FIG. 6b illustrate schematic diagrams of two diffractive optical elements according to embodiments of the disclosure. The diffractive optical element shown in FIG. 6a has a smaller light transmissive region, while the diffractive optical element shown in FIG. 6b has a larger light transmissive region. As shown in FIG. 6a and FIG. 6b, the smaller the light transmissive region, the more limited the light intake range, leading to more significant blockage of the aperture in the camera head and a greater negative impact on the camera imaging performance. Conversely, the larger the light transmissive region, the wider the light intake range, resulting in less aperture blockage and a smaller impact on the camera imaging performance.

In some alternative implementations, the patterned region in the diffractive optical element may have a dimension less than or equal to a spacing size between adjacent patterned regions in the diffractive optical element. Optionally, the light transmissive region in the diffractive optical element has a dimension greater than or equal to the dimension of the patterned region.

For the diffractive optical element 10, when applied in the laser field, the dimension of the individual patterned region 11 is typically between 1.5 mm and 2 mm. However, if the unit dimension of the individual patterned region 11 is too large or too small, it can lead to a reduction in diffraction efficiency. In embodiments of the disclosure, to achieve a high-definition imaging effect, the dimension of the individual patterned region 11 in the diffractive optical element 10 is designed to ranging from 0.3 mm to 1 mm. Additionally, the dimension of the light transmissive region 12 between adjacent patterned regions 11 is configured to range from 1 mm to 10 mm. By increasing the dimension of the light transmissive region 12, the amount of background light transmitted into the aperture is significantly enhanced. As an example, if the light transmissive region 12 is enlarged from 0.9 mm by 0.9 mm to 1.0 mm by 1.0 mm, the light transmittance of the light transmissive region 12 can be boosted by 19%, thereby significantly improving the quality of the background imaging by the camera.

The dimensions of the individual patterned regions 11 and the light transmissive region 12 between neighboring patterned regions 11 can be specifically adjusted based on the specifications of the camera head to which the diffractive optical element is applied. Taking the dimension of the light transmissive region 12 between neighboring patterned regions 11 as an example, for a terminal device such as a cellular phone, which has a relatively small camera head and correspondingly smaller diffractive optical element, the light transmissive region 12 between neighboring patterned regions 11 can be dimensioned relatively small, typically within a range of 1 mm to 5 mm. By comparison, for a camera such as a digital camera, which has a relatively large camera head and correspondingly larger diffractive optical element, the light transmissive region 12 between neighboring patterned regions 11 can be dimensioned relatively large, typically within a range of 3 mm to 10 mm. The dimensions of the individual patterned regions 11 and the light transmissive region 12 between neighboring patterned regions 11 can also be adjusted according to the complexity of the patterns in the patterned regions 11. Generally, the more complex the pattern, the larger the dimension of the individual patterned region 11 may need to be, in order to reduce the processing difficulty of the diffractive optical element 10. When the cross-sectional area of the diffractive optical element 10 is fixed, enlarging the individual patterned regions 11 will reduce the dimension of the light-transmitting regions 12 between neighboring patterned regions 11.

In the implementation of the disclosure, by reducing the area of the patterned regions 11 in the diffractive optical element 10 and increasing the area of the light transmissive region 12, the transmission rate of background light can be increased. This approach can also lower the diffraction efficiency of the diffractive optical element 10, thereby enhancing the clarity of the captured image. Additionally, it suppresses the diffraction patterns formed by light from other diffraction orders, significantly improving imaging quality and overall image display effect.

The disclosure is implemented such that for each optical microstructure in the patterned region 11, the pixel resolution of its structural dimension depends on the number of sampling points set during the processing of the micro-optical structure. The more sampling points that are set, the higher the pixel resolution of the optical microstructure. Moreover, when the dimension of the individual patterned region 11 is fixed, increasing the number of sampling points can raise the pixel resolution for imaging the optical microstructure. This refinement enhances the diffraction pattern formed by light from other diffraction orders, resulting in a better imaging effect for the image captured by the camera. However, when the dimension of the individual patterned region 11 is fixed, increasing the number of sampling points will result in thinner line widths during the processing of the optical microstructure. This will necessitate a more advanced and precise preparation process. Therefore, the number of sampling points corresponding to the optical microstructures needs to be carefully controlled within an appropriate range. This approach ensures a good final imaging effect while avoiding a significant increase in processing difficulty and preparation costs. Optionally, depending on desired complexity of the pattern, the patterned region of the diffractive optical element is configured with 100 to 1000 sampling points. A higher number of sampling points leads to more refined light spots, and in the case where the dimension of the patterned region is fixed, increasing the number of sampling points results in a thinner processing line width, which facilitates the optimization and minimization of stray spots. The number of sampling points can also be selected based on the complexity of the optical microstructure. Generally, the more complex the optical microstructure, the more sampling points are required.

The principle behind the diffractive optical element 10 is rooted in diffractive optics, where the element modulates the energy distribution and phase of the incident light using optical microstructures. These microstructures have dimensions on the same order of magnitude as the wavelength of the laser. The Optical microstructure is a stepped structure, typically categorized into 2, 4, 8, or 16 orders. As the number of steps increases, the width of each step decreases, making the processing more challenging. Additionally, a higher number of steps generally leads to higher diffraction efficiency. Therefore, to reduce the diffraction efficiency of the diffractive optical element 10, the number of orders corresponding to the optical microstructure should be limited and not excessive. In embodiments of the disclosure, if a symmetrical pattern is required in the patterned region of the diffractive optical element, a one-step design is utilized. This means the pattern may be prepared in 2 orders by a single etching. Alternatively, if an asymmetrical pattern is required in the patterned region of the diffractive optical element, a two-step design is utilized. This means the pattern may be prepared in 4 orders by double etching. By reducing the number of steps in the optical microstructure, the diffraction efficiency is lowered, which in turn reduces stray spots in the images captured by the camera. Additionally, this approach will simplify the processing of the diffractive optical element 10, making it less challenging to manufacture.

In the disclosed implementation, the diffractive optical element is capable of being provided at a camera head of the camera. Specifically, the diffractive optical element further comprises a connecting structure, which is configured to connect with the camera head of the camera. The connection structure can be implemented depending on the type of the diffractive optical element. As an example, when the diffractive optical element is an optical diaphragm, the connection structure could be an adhesive layer formed on one surface of the diaphragm. Optionally, this adhesive layer could either be a coating applied directly to the surface or achieved by plasma-treating the surface of the diaphragm to increase its surface energy, thereby enhancing its adhesive properties. As another example, when the diffractive optical element is a lens, the connection structure could be a lens holder, which would serve a dual purpose: securely holding the lens that contains the diffractive optical element and enabling the lens to be connected to the camera head.

It should be understood that the diffractive optical elements in the embodiments of the disclosure are not limited to product types like optical diaphragms or lenses; they could also include other types, such as cell phone cases.

Embodiments of the disclosure also provide a camera that includes the aforementioned diffractive optical element. Optionally, the diffractive optical element can be detachably connected to the camera. This allows the camera to capture images with a predefined pattern integrated into each respective photograph. Moreover, since the camera can simultaneously image the diffractive pattern and the background, which are seamlessly fused during the imaging process, allowing the pattern to be naturally incorporated into the captured image. This will enhance the overall image display effect.

The disclosed diffractive optical element is designed using an inverse design approach, achieved by reducing the diffraction efficiency of the diffractive optical element. Lowering the diffraction efficiency causes non-primary diffracted light to become dim or even invisible, significantly reducing stray spots in the captured background image. The disclosure utilizes an inverse design to reduce the area of the patterned region and increase the light transmissive region. This approach dilutes the light spots generated by secondary diffracted rays, minimizing their appearance on captured images. Simultaneously, it reduces the blockage of the camera aperture, allowing more background light intake, which improves shutter response speed. Consequently, the camera can capture sufficient background light, leading to high-definition images with enhanced clarity and detail.

It should be noted that the sequence of embodiments described above is solely for explanatory purposes and does not imply any superiority or inferiority among the embodiments. The above description introduces some embodiments of the disclosure. Other embodiments will fall within the scope of the appended claims. In some cases, the actions or steps recorded in the claims may be performed in a different order than in the embodiments and still achieve the desired result. In addition, the processes depicted in the accompanying drawings do not necessarily require a specific or sequential order to be shown in order to achieve the desired result. In some implementations, multitasking and parallel processing are also possible or may be advantageous.

The various embodiments in this specification are described in a progressive manner, the same or similar parts among the various embodiments can make reference with each other, and focus of each embodiment are those difference from other embodiments. In particular, for the system embodiment, the description thereof is relatively brief since it is basically similar to the process embodiment, and the relevant can be referred to a part of the description of the process embodiment.

Those skilled in the art will understand that all or some of the steps required to implement the embodiments can be accomplished by hardware, or by a program that instructs the relevant hardware to perform the necessary functions. Such a program can be stored in a computer-readable storage medium, which may include read-only memory (ROM), a disk, a CD-ROM, or similar media.

The above description pertains to preferred embodiments of the disclosure and is not intended to limit the invention. Any modifications, equivalent replacements, improvements, or similar changes made within the principles of the invention shall fall within the scope of protection of this disclosure.

What is claimed is:

1. A diffractive optical element, wherein the diffractive optical element is arrangeable at a camera head of a camera for assisting the camera in imaging;
the diffractive optical element is configured by inverse design;
the diffractive optical element is inversely designed to minimize stray spots during image capture and to enhance its light transmission capability;
the inverse design is applied to reduce an etching depth of a patterned region in the diffractive optical element, thereby lowering primary and secondary diffraction efficiency, increasing light transmission capacity, and minimizing stray spots in captured images; and
the inverse design is further applied to narrow the patterned region in the diffractive optical element, thereby lowering diffraction efficiency and increasing light intake through a light transmissive region, which enables a camera aperture to obtain more light, enhancing background light intake, shutter response speed, and overall quality in imaged background.

2. The diffractive optical element according to claim 1, wherein
an etching depth value is determined via auxiliary software design for the diffractive optical element, and
an actual etching depth is reduced to a range between 20% and 80% of the designed etching depth value depending on patterning complexity, in order to lower the diffraction efficiency of the diffractive optical element.

3. The diffractive optical element according to claim 1, wherein
the patterned region in the diffractive optical element has a dimension less than or equal to a spacing dimension between adjacent patterned regions in the diffractive optical element.

4. The diffractive optical element according to claim 1, wherein
the inverse design is further applied to enlarge the light transmissive region in the diffractive optical element in order to enable the camera aperture to obtain more light.

5. The diffractive optical element according to claim 1, wherein
the light transmissive region in the diffractive optical element has a dimension greater than or equal to the dimension of the patterned region.

6. The diffractive optical element according to claim 1, wherein
the patterned region of the diffractive optical element is configured with 100 to 1000 sampling points, depending on the patterning complexity, a higher number of sampling points leads to more refined light spots, and
in the case where the dimension of the patterned region is fixed, increasing the number of sampling points results in a thinner processing line width, which facilitates the optimization and minimization of stray spots.

7. The diffractive optical element according to claim 2, wherein
the etching depth of the patterned region affects its light transmittance, and the actual etching depth is reduced to a range between 20% and 80% of the designed etching depth value in order to improve the light transmittance of the patterned region.

8. The diffractive optical element according to claim 1, wherein
if a symmetrical pattern is required in the patterned region of the diffractive optical element, the pattern is prepared in 2 orders by a single etching; or
If an asymmetrical pattern is required in the patterned region of the diffractive optical element, the pattern is prepared in 4 orders by double etching.

9. The diffractive optical element according to claim 1, wherein
as the camera aperture varies from larger to smaller, a corresponding amount of light intake changes from more to less;
as the dimension of the patterned region in the diffractive optical element varies from smaller to larger, corresponding occlusion of the aperture increases from less to more, leading to a reduction in the amount of light intake from more to less;
an increased amount of light intake shortens shutter time, achieving the same exposure in a shorter duration, thereby preventing image blurring when photographing fast-moving objects;
the dimension of the light transmissive region in the diffractive optical element is enlarged in a dark environment, allowing for an increased amount of light intake to achieve the same exposure duration with lower sensitivity, resulting in cleaner, high signal-to-noise ratio images.

10. A camera, comprising a diffractive optical element according to claim 1, wherein
the diffractive optical element is detachably attached to a camera head of a camera.
